(19) United States
(12) Patent Application Publication
(10) Pub. No.: US 2003/0043365 A1
(43) Pub. Date: Mar. 6, 2003

(54) Optical media detection system

(75) Inventors: Gary A. Ross, Fife (GB); Barrie Clark, Dundee (GB)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/226,519

(22) Filed: Aug. 23, 2002

(30) Foreign Application Priority Data
Sep. 6, 2001 (GB) 0121550.8

(51) Int. Cl. G06K 9/74

(52) U.S. Cl. 356/71

(57) ABSTRACT

An optical media detection system (10) is described. The system (10) comprises a light source (16), a transmitted light detector (18), and a reflected light detector (20). The source (16) and the detectors (18,20) are mutually arranged and oriented such that the reflected light detector (20) detects light reflected from a portion of a media item (14) irradiated with light from the source (16), and the transmitted light detector (18) detects light transmitted through the portion of the media item (14) irradiated with light from the source (16). When a substantial amount of light is transmitted and reflected from a portion of the media item (14) then this indicates that the portion of the media item (14) irradiated is an optically transparent window, thereby enabling the system (10) to distinguish between a transparent window and a void.

### BACKGROUND OF THE INVENTION

The present invention relates to an optical media detection system. In particular, the invention relates to low cost optical media detection system for detecting sheet media, such as banknotes. The invention also relates to a self-service terminal (SST), such as an automated teller machine (ATM), incorporating such an optical media detection system.

ATMs are public access terminals that provide a convenient, reliable, and secure source of cash and other financial transactions and services in an unattended environment. In addition to dispensing cash to users, ATMs can also receive cash deposits from users. The cash received from one user may be dispensed to another user, typically referred to as “recycling”.

Receiving cash from a user at an ATM is a higher risk for the ATM owner than dispensing cash because the ATM has no control over the banknotes received during a deposit operation. The deposited banknotes may be in poor condition (which may cause the ATM's banknote transport mechanism to jam), or they may comprise one or more counterfeit banknotes.

It is therefore important to determine the condition of each deposited banknote to ensure that there are no voids (holes) or large tears that will prevent the banknote from being transported reliably by the ATM. It is also important to ensure that the notes are not counterfeit.

Traditionally, banknotes were printed on a rag-based paper substrate, which was inherently opaque. For economical reasons, many types of banknote are now printed on a synthetic polymer substrate, which is optically transparent. When a banknote is to be printed, most of the substrate is printed with an opaque background, and then the banknote graphics are printed onto the background. However, for security reasons, an area of the substrate is typically left free of any background and graphics so that an opaque material cannot be used for producing counterfeit banknotes. This transparent area is referred to as a “window”.

These windows create a problem for traditional optical note detection systems because such systems measure relative transmittance of a note using an emitter on one side of the banknote transport mechanism and a detector on the opposite side of the banknote transport mechanism.

These systems assume that the banknote being detected has an optically opaque substrate, so that a large increase in transmission is interpreted as a trailing edge of a note or a leading edge of a void or tear; and a large decrease in transmission is interpreted either as a leading edge of a note or a trailing edge of a void or tear. Using such systems, a window in a polymer substrate note will cause large increases in transmission, which may lead to the note being rejected as being of poor condition (because the window is interpreted as a void or tear) or a counterfeit (because the window is interpreted as the edge of a note having an incorrect length).

### SUMMARY OF THE INVENTION

It is among the objects of an embodiment of the present invention to obviate or mitigate the above disadvantage or other disadvantages associated with prior art optical note detection systems when used with polymer substrate notes.

According to a first aspect of the present invention there is provided an optical media detection system comprising a light source, a transmitted light detector, and a reflected light detector; the source and the detectors being mutually arranged and oriented such that the reflected light detector detects light reflected from a portion of a media item irradiated with light from the source, and the transmitted light detector detects light transmitted through the portion of the media item irradiated with light from the source.

Preferably, the system includes a controller for indicating the state of the detectors.

Preferably, the controller includes means (such as software) for validating that the media item is authentic by comparing detected dimensions of the media item and any window present on the media item, with dimensions of a corresponding authentic media item.

The media detection system is particularly suitable for detecting valuable media, including financial documents such as banknotes, checks, and such like.

By virtue of this aspect of the present invention an optical detection system can detect an optically transparent window in a media item because the window will reflect some light, which is detected by the reflected light detector; whereas a void or tear will not reflect any light.

This aspect of the invention has the advantage that optically transparent windows can be detected easily and quickly using a low cost detection system.

According to a second aspect of the present invention there is provided a method of detecting media items, the method comprising the steps of: transporting a media item along a transport path; irradiating a portion of the media item with light from a source; detecting light reflected from the portion of the media item; detecting light transmitted through the portion of the media item; and determining from the detected reflected light and the detected transmitted light whether the portion of the media item is an optically transparent window.

If a large amount of transmitted light is detected, and no (or very little) reflected light is detected, then this indicates that either no media is present, or there is a void or tear in the media at that portion.

If no (or little) transmitted light is detected, and a large amount of reflected light is detected, then this indicates that optically opaque media is present at that portion.

If a relatively large amount of transmitted light is detected, and some reflected light is detected, then this indicates that an optically transparent window is present at that portion.

The method of detecting media items may include the further steps of: comparing detected dimensions of a media item and any window therein, with dimensions of a corresponding authentic media item and any window therein; and validating the authenticity of the media item in the event that all corresponding dimensions match.

According to a third aspect of the present invention there is provided a self-service terminal including the optical note detection system of the first aspect of the invention.

### BRIEF DESCRIPTION OF THE DRAWINGS

These and other aspects of the present invention will be apparent from the following specific description, given by way of example, with reference to the accompanying drawings, in which:

FIG. 1 is a simplified schematic diagram of an optical media detection system arrangement according to one embodiment of the present invention;

FIG. 2 is a simplified schematic diagram of the optical system of FIG. 1, illustrating the output of two detectors with no media item present in a detection area;

FIG. 3 is a simplified schematic diagram of the optical system of FIG. 1, illustrating the output of two detectors with a media item present and an opaque portion of the item being irradiated by a light source; and

FIG. 4 is a simplified schematic diagram of the optical system of FIG. 1, illustrating the output of two detectors with a media item present and an optically transparent portion of the item being irradiated by a light source.

### DETAILED DESCRIPTION

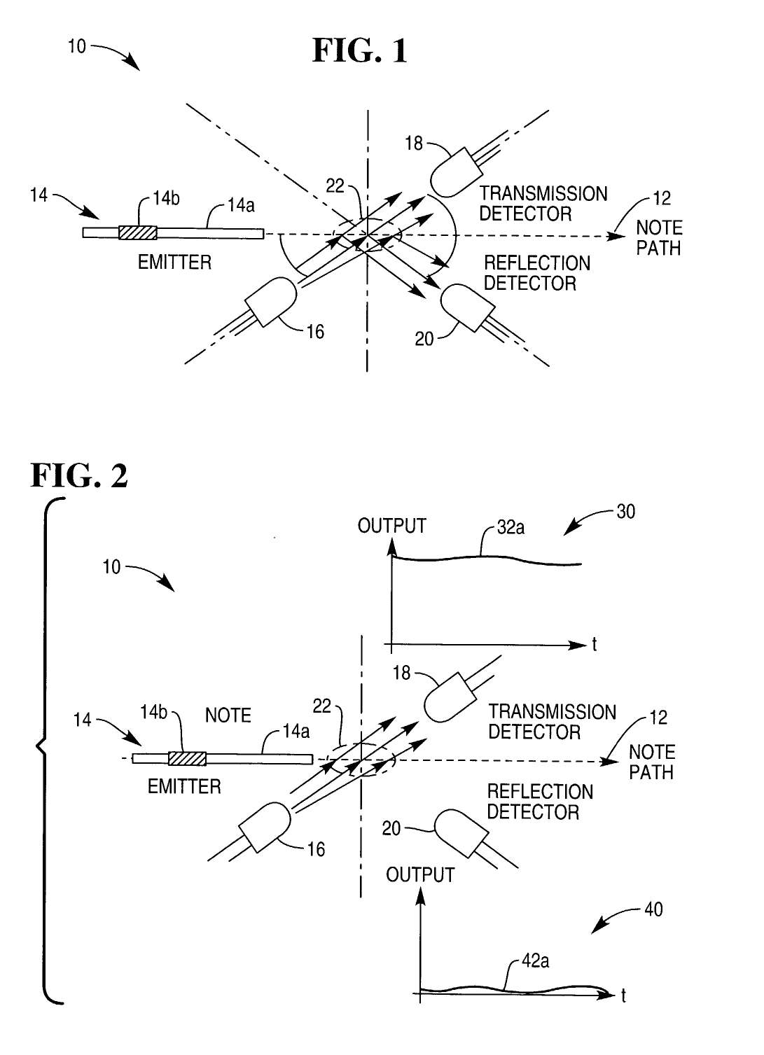

Referring to FIG. 1, an optical media detection system 10 (in the form of a banknote detection system) comprises a media transport path 12, along which a media item 14 (in the form of a banknote) is conveyed by a transport mechanism (not shown).

The banknote 14 comprises an optically opaque area 14a surrounding an optically transparent window 14b. The system 10 further comprises a light emitter 16 located on a first (lower) side of the transport path 12, a transmitted light detector 18 located on a second (upper) side of the transport path 12, and a reflected light detector 20 located on the first (lower) side of the transport path 12.

The emitter 16 and the two detectors 18,20 are arranged and oriented towards a detection area 22 (shown circled in chain line) on the media transport path 12. The emitter 16 and detectors 18,20 are arranged such that the emitter 16 irradiates any portion of a media item 14 present at the detection area 22; the transmitted light detector 18 detects light transmitted through any portion of the media item 14 present at the detection area 22; and the reflected light detector 20 detects light reflected from any portion of the media item 14 present at the detection area 22.

In this arrangement, the emitter 16 is positioned at an angle between an orientation normal to the media transport path 12 and an orientation that causes total internal reflection of incident light. The transmitted light detector 18 and the reflected light detector 20 are positioned symmetrically opposite each other, so that the angle between the emitter 16 and the transport path 12 is approximately the same as the angle between the reflected light detector 20 and the transport path 12, which is approximately the same as the angle between the transmitted light detector 18 and the transport path 12.

Initially, no note 14 is present in the detection area 22 because the transport mechanism (not shown) has not transported the note 14 sufficiently far along the transport path 12. A transmission response graph 30 and a reflection response graph 40 (as shown in FIG. 2) illustrate the response from each of the detectors 18,20 respectively.

Each graph 30,40 has detected light intensity on the y-axis (in arbitrary units) and time on the x-axis. The transmission response 32a is high and the reflection response 42a is low because no portion of the banknote 14 is present at the detection area 22. The responses 32a,42a are not perfectly flat because of noise from the detector, background light, and such like.

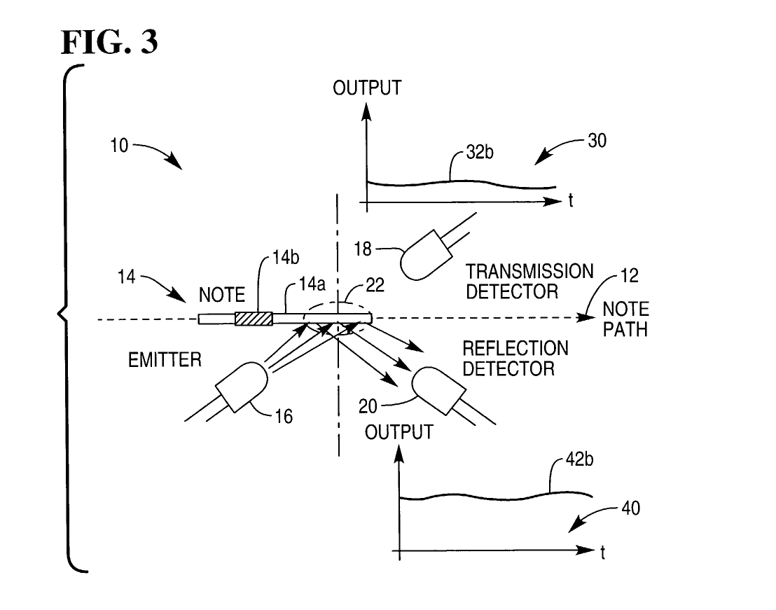

To detect the note 14, the transport mechanism (not shown) conveys the note 14 along the transport path 12 so that a front (optically opaque) portion of the note 14 enters the detection area 22, as shown in FIG. 3. At this point, the transmission response 32b becomes low and the reflection response 42b becomes high because the optically opaque portion of the note reflects most of the light irradiating it. A small amount of light is transmitted by the optically opaque portion 14a and detected by the transmitted light detector 18.

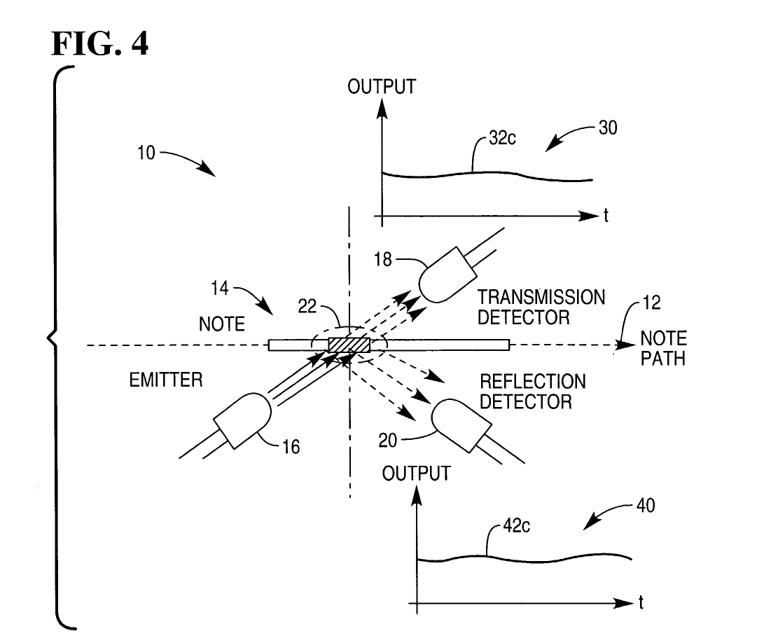

As the transport mechanism (not shown) conveys the note 14 further along the transport path 12, the optically transparent window 14b enters the detection area 22, as shown in FIG. 4. At this point, the transmission response 32c becomes higher (but not as high as when no note 14 is present); whereas, the reflection response 42c becomes slightly lower (but much higher than when no note 14 is present).

The transmission response 32c is not as high as when no note is present because although the optically transparent window 14b allows light to pass therethrough, some light is scattered and reflected by the surface of the note 14 at the window 14b.

Similarly, the reflection response 42c is slightly lower than when an optically opaque portion 14a of the note is being irradiated because there is no diffuse (non-specular) reflection from the window, only specular reflection. However, the reflection response 42c is still relatively high, as most of the reflected light is due to specular reflection, not diffuse reflection. This is because the emitter 16 is oriented towards the detection area 22 at the same angle as the reflected light detector 20, so that the incidence angle equals the reflection angle, which is the condition for high specular reflection. The amount of specular reflection from a surface depends on the smoothness of the surface, not the color of the surface.

As the transport mechanism (not shown) conveys the note 14 further along the transport path 12, the trailing edge of the note 14 leaves the detection area 22, and the transmission and reflection responses are the same as for the position of the banknote 14 in FIG. 2.

Thus, when a window in a note is detected there is a substantial response for both the transmission and reflection responses; whereas, when a void is present, or when no note is present, there is minimal reflection response (as the only response detected is due to noise, background light, and such like).

The detection system 10 includes control circuitry (not shown) to indicate whether:

(i.) a window is detected, that is, both responses 32,42 are high;

(ii.) an opaque portion of a note is detected, that is, the transmission response 32 is low but the reflection response 42 is high;

(iii.) a void or no note is detected, that is, the transmission response 32 is high but the reflection response 42 is low; or

(iv.) the detection system is not working, that is, the transmission response 32 is low and the reflection response 42 is low.

The control circuitry may be in the form of logic gates, or a microcontroller executing a simple algorithm for indicating whether the detectors are in state (i.), (ii.), (iii.), or (iv.). If a microcontroller is used, then the microcontroller may be programmed with dimensions of banknotes to be accepted, and also with details of whether a banknote having a void should be accepted. If a banknote having a void is acceptable, then the microcontroller may store details of the maximum size of void and/or number of voids that may be present in a banknote that is to be accepted by the detection system.

It will now be appreciated that the above embodiment has the advantage that a simple, low cost optical system can be used to distinguish in a non-contact manner between an optically transparent window in a polymer note, an opaque region in a polymer note, and a void or a gap between notes.

It will be appreciated that the media detection system is suitable for use as a stand-alone unit, or for incorporation into a conventional self-service terminal, such as an ATM, which requires a media detector or a media validator.

Various modifications may be made to the above described embodiment within the scope of the invention, for example, in other embodiments, different types of media items may be detected. In other embodiments, the emitter and reflection detector may be located on an upper side of the transport path, and the transmission detector may be located on a lower side of the transport path. In other embodiments, the media item may be stationary and the emitter and detectors may move. In other embodiments, the detection system may be located in a transverse orientation rather than in a horizontal orientation.

What is claimed is:

1. An optical media detection system comprising:
a light source;
a transmitted light detector; and
a reflected light detector;
the source and the detectors being mutually arranged and oriented such that the reflected light detector detects light reflected from a portion of a media item irradiated with light from the source, and the transmitted light detector detects light transmitted though the portion of the media item irradiated with light from the source.

2. A system according to claim 1, further comprising means defining a transport path along which a media item is conveyed.

3. A system according to claim 2, further comprising a controller for indicating the state of the detectors.

4. A system according to claim 3, wherein the controller includes means for validating that a media item is authentic by comparing detected dimensions of the media item and any window present on the media item, with dimensions of a corresponding authentic media item.

5. An optical media detection system comprising:
means for irradiating a portion of a media item with light;
means for detecting light transmitted through a portion of a media item irradiated with light from the light source; and
means for detecting light reflected from a portion of a media item irradiated with light from the light source.

6. A system according to claim 5, further comprising means defining a transport path along which a media item is conveyed.

7. A system according to claim 5, further comprising means for validating that a media item is authentic by comparing detected dimensions of the media item and any window present on the media item, with dimensions of a corresponding authentic media item.

8. A method of detecting media items, the method comprising the steps of:
transporting a media item along a transport path;
irradiating a portion of the media item with light from a source;
detecting light reflected from the portion of the media item;
detecting light transmitted through the portion of the media item; and
determining from the detected reflected light and the detected transmitted light whether the portion of the media item is an optically transparent window.

9. A method according to claim 8, further the steps of:
comparing detected dimensions of a media item and any window therein, with dimensions of a corresponding authentic media item and any window therein; and
validating the authenticity of the media item in the event that all corresponding dimensions match.

10. A method of detecting media items, the method comprising the steps of:
transporting a media item along a transport path;
irradiating a portion of the media item with light from a source;
detecting light reflected from the portion of the media item;
detecting light transmitted through the portion of the media item; and
determining whether the portion of the media item is an optically transparent window based upon light reflected from the portion of the media item and light transmitted through the portion of the media item.

11. A self-service terminal comprising:
means defining a media item transport path along which a media item is conveyed;
means for irradiating a portion of a media item conveyed along the media item transport with light;
means for detecting light transmitted through a portion of a media item irradiated with light from the light source; and
means for detecting light reflected from a portion of a media item irradiated with light from the light source.

12. A self-service terminal according to claim 11, further comprising means for validating that a media item is authentic by comparing detected dimensions of the media item and any window present on the media item, with dimensions of a corresponding authentic media item.

13. An automated teller machine (ATM) comprising:
means defining a banknote transport path along which a banknote is conveyed;
means for irradiating a portion of a banknote conveyed along the banknote transport path with light;
means for detecting light transmitted through a portion of a banknote irradiated with light from the light source; and
means for detecting light reflected from a portion of a banknote irradiated with light from the light source.

14. An ATM according to claim 13, further comprising means for validating that a banknote is authentic by comparing detected dimensions of the banknote and any window present on the banknote, with dimensions of a corresponding authentic banknote.
